(19) United States
(12) Patent Application Publication
(10) Pub. No.: US 2026/0161459 A1
(43) Pub. Date: Jun. 11, 2026

(54) CLOUD APPLICATION SCHEDULING METHOD AND APPARATUS, ELECTRONIC DEVICE, AND STORAGE MEDIUM

(71) Applicant: CLOUD INTELLIGENCE ASSETS HOLDING (SINGAPORE) PRIVATE LIMITED, Singapore (SG)

(72) Inventors: Liezhuo ZHANG, Hangzhou (CN); Xiantao ZHANG, Hangzhou (CN); Jinkui REN, Hangzhou (CN)

(21) Appl. No.: 18/851,005

(22) PCT Filed: Mar. 13, 2023
(86) PCT No.: PCT/CN2023/080976

§ 371 Date: Sep. 25, 2024

(30) Foreign Application Priority Data
Mar. 25, 2022 (CN) 202210302339.1

(51) Int. Cl. G06F 9/50; G06F 9/455

(52) U.S. Cl. CPC G06F 9/5027; G06F 9/45558; G06F 2009/45562; G06F 2209/5011; G06F 2209/5014; G06F 2209/503

(57) ABSTRACT

Embodiments of the present application provide a cloud application scheduling method and apparatus, an electronic device, and a storage medium, applied to a cloud application scheduling process, where the method includes: obtaining a cloud application for using by a user, and performing an abstraction on an operation unit required by the cloud application to obtain an instance; where the instance is obtained by performing abstraction uniformly based on operation units of various different application ecosystems, and the instance includes resource occupancy; and performing elastic scheduling on the instance in any application ecosystem according to the resource occupancy of the instance and usage of a current instance.

### CROSS-REFERENCE TO RELATED APPLICATIONS

This application is a National Stage of International Application No. PCT/CN2023/080976, and filed on Mar. 13, 2023, which claims priority to Chinese patent application No. 202210302339.1, entitled “CLOUD APPLICATION SCHEDULING METHOD AND APPARATUS, ELECTRONIC DEVICE, AND STORAGE MEDIUM” and filed to the China National Intellectual Property Administration on Mar. 25, 2022. The disclosures of the aforementioned applications are hereby incorporated by reference in their entireties.

### TECHNICAL FIELD

The present application relates to the field of computer technologies and, in particular, to a cloud application scheduling method, a cloud application scheduling apparatus, a corresponding electronic device, and a corresponding computer storage medium.

### BACKGROUND

Cloud manufacturers can provide an application running in cloud resources to a user for local use. The application running in the cloud resources can be called a cloud application. Its working principle is mainly that it can change a use mode of traditional software “local installation and local computing” to “ready-to-use” services, so as to connect through the Internet or the local area network and control a remote server cluster to complete service logic or computing tasks, which can realize application virtualization based on resources on the cloud, and use cloud resources to run traditional software.

When providing the cloud application to the user for local use, the current cloud manufacturers implement the cloud application using an abstract concept. However, due to different characteristics of different operating systems, manufacturers have different scheduling granularities and methods for different operating systems, resulting in inconsistent concepts abstracted from different operating systems. When scheduling the cloud application using different operating systems, additional scheduling logic and processes are required for different application ecosystems.

### SUMMARY

In view of the above problems, embodiments of the present application are proposed, so as to provide a cloud application scheduling method, a cloud application scheduling apparatus, a corresponding electronic device, and a corresponding computer storage medium that overcome or at least partially solve the above problems.

An embodiment of the present application discloses a cloud application scheduling method, applied to a cloud application scheduling process, and the method includes:
obtaining a cloud application for using by a user, and performing an abstraction on an operation unit required by the cloud application to obtain an instance; where the instance is obtained by performing abstraction uniformly based on operation units of various different application ecosystems, and the instance includes resource occupancy;
performing elastic scheduling on the instance in any application ecosystem according to the resource occupancy of the instance and usage of a current instance.

In an implementation, the cloud application for using by the user includes one or a set of running cloud applications for connection by the user, the various different application ecosystems includes a Linux ecosystem, a Windows ecosystem, and an Android ecosystem, the performing the abstraction on the operation unit required by the cloud application to obtain the instance includes:
in the Linux ecosystem, mapping an operation unit required by one or a set of running cloud applications for connection by the user to a set of pods in the Linux ecosystem, and abstracting the pod to obtain the instance;
and/or, in the Windows ecosystem, mapping an operation unit required by one or a set of running cloud applications for connection by the user to a system session window in the Windows ecosystem, and abstracting the system session window to obtain the instance;
and/or, in the Android ecosystem, mapping an operation unit required by one or a set of running cloud applications for connection by the user to an application in the Android ecosystem, and abstracting the application to obtain the instance.

In an implementation, the method further includes:
obtaining various instances obtained by the abstraction and configuration information of the various instances, and collecting instances with the same configuration information to obtain an instance group.

In an implementation, the configuration information of the instance group where the instance is located includes an elastic strategy, the resource occupancy of the instance is determined based on a current actual number of connected instances in the instance group where the instance is located, and the usage of the current instance is determined based on a current number of reserved instances in the instance group where the instance is located;
the performing the elastic scheduling on the instance in any application ecosystem according to the resource occupancy of the instance and the usage of the current instance includes:
based on the elastic strategy, performing calculation to obtain a target number of reserved instances by using the current actual number of connected instances in the instance group where the instance is located and the current number of reserved instances;
performing the elastic scheduling on the instance in any application ecosystem based on a comparison result between the target number of reserved instances and the current number of reserved instances.

In an implementation, the performing the elastic scheduling on the instance in any application ecosystem based on the comparison result between the target number of reserved instances and the current number of reserved instances includes:
based on that the comparison result is that the current number of reserved instances is greater than the target number of reserved instances, deleting an excess reserved instance;
based on that the comparison result is that the current number of reserved instances is less than the target number of reserved instances, creating a reserved instance to reserve the instance.

In an implementation, the instance group where the instance is located is bound to a node pool, the node pool is bound to several machine nodes, a machine node remaining resource exists in the bound node pool, and the usage of the current instance is determined based on a required resource of the instance in the instance group;
the deleting the excess reserved instance includes:
when the machine node remaining resource is greater than the required resource, deleting the excess reserved instance through performing a release operation on a node in the node pool bound to the instance group where the instance is located.

In an implementation, the instance group where the instance is located is bound to a node pool, the node pool is bound to several machine nodes, a machine node remaining resource exists the bound node pool, and the usage of the current instance is determined based on a required resource of the instance in the instance group;
the creating the reserved instance to reserve the instance includes:
when the machine node remaining resource is less than the required resource, creating the reserved instance through performing a new creation operation on a node in the node pool bound to the instance group where the instance is located, and scheduling the excess reserved instance of the instance group where the instance is located to a new created node.

An embodiment of the present application also discloses a cloud application scheduling apparatus, applied to a cloud application scheduling process, and the apparatus includes:
an instance abstraction module, configured to obtain a cloud application for using by a user, and perform an abstraction on an operation unit required by the cloud application to obtain an instance; where the instance is obtained by performing abstraction uniformly based on operation units of various different application ecosystems, and the instance includes resource occupancy;
an elastic scheduling module, configured to perform elastic scheduling on the instance in any application ecosystem according to the resource occupancy of the instance and usage of a current instance.

In an implementation, the cloud application for using by a user includes one or a set of running cloud applications for connection by the user, the various different application ecosystems includes a Linux ecosystem, a Windows ecosystem, and an Android ecosystem, the instance abstraction module may include:
an instance abstraction sub-module, configured to, in the Linux ecosystem, map an operation unit required by one or a set of running cloud applications for connection by the user to a set of pods in the Linux ecosystem, and abstract the pod to obtain the instance; and/or, in the Windows ecosystem, map an operation unit required by one or a set of running cloud applications for connection by the user to a system session window in the Windows ecosystem, and abstract the system session window to obtain the instance; and/or, in the Android ecosystem, map an operation unit required by one or a set of running cloud applications for connection by the user to an application in the Android ecosystem, and abstract the application to obtain the instance.

In an implementation, the apparatus further includes:
an instance group collection module, configured to obtain various instances obtained by the abstraction and configuration information of the various instances, and collect instances with the same configuration information to obtain an instance group.

In an implementation, the configuration information of the instance group where the instance is located includes an elastic strategy, the resource occupancy of the instance is determined based on a current actual number of connected instances in the instance group where the instance is located, and the usage of the current instance is determined based on a current number of reserved instances in the instance group where the instance is located; and the elastic scheduling module includes:
a target reserved instance number determination sub-module, configured to, based on the elastic strategy, performing calculation to obtain a target number of reserved instances by using the current actual number of connected instances in the instance group where the instance is located and the current number of reserved instances;
an elastic scheduling sub-module, configured to perform the elastic scheduling on the instance based on a comparison result between the target number of reserved instances and the current number of reserved instances.

In an implementation, the elastic scheduling sub-module includes:
a reserved instance deletion unit, configured to delete an excess reserved instance, when the comparison result is that the current number of reserved instances is greater than the target number of reserved instances;
a reserved instance creation unit, configured to create a reserved instance to reserve the instance, when the comparison result is that the current number of reserved instances is less than the target number of reserved instances.

In an implementation, the instance group where the instance is located is bound to a node pool, the node pool is bound to several machine nodes, a machine node remaining resource exists in the bound node pool, and the usage of the current instance is determined based on a required resource of the instance in the instance group, and the reserved instance deletion unit includes:
a node releasing sub-unit, configured to delete, when the machine node remaining resource is greater than the required resource, the excess reserved instance through performing a release operation on a node in the node pool bound to the instance group where the instance is located.

In an implementation, the instance group where the instance is located is bound to a node pool, the node pool is bound to several machine nodes, a machine node remaining resource exists the bound node pool, and the usage of the current instance is determined based on a required resource of the instance in the instance group; and the reserved instance creation unit includes:
a node creation sub-unit, configured to create, when the machine node remaining resource is less than the required resource, the reserved instance through performing a new creation operation on a node in the node pool bound to the instance group where the instance is located, and schedule the excess reserved instance of the instance group where the instance is located to a new created node.

An embodiment of the present application also discloses an electronic device, including: a processor, a memory, and a computer program stored in the memory and capable of running in the processor; and when executed by the processor, the computer program achieves steps of the cloud application scheduling method according to any item.

An embodiment of the present application also discloses a computer readable storage medium, where the computer readable storage medium stores a computer program which, when executed by the processor, implements steps of the cloud application scheduling method according to any item.

The embodiments of the present application includes the following advantages:
in the embodiment of the present application, the operation unit required by the cloud application for using by the user are abstracted through the cloud application scheduling process, and the instance in any application ecosystem is elastically scheduled based on the resource occupancy of the abstracted instance and the usage of the current instance, where the abstracted instance is obtained by performing abstraction uniformly based on operation units of various different application ecosystems. That is, through utilizing underlying abstraction capabilities for different application ecosystems, it achieves unified elastic scheduling capabilities for cloud applications in different application ecosystems, which not only reduces the development cost of the elastic scheduling function for the cloud application service manufacturer, but also provides the cloud application manager with a unified user experience and reduces the understanding cost.

### BRIEF DESCRIPTION OF DRAWINGS

FIG. 1 is a flowchart of steps of an embodiment of a cloud application scheduling method of the present application.

FIG. 2 is a schematic diagram of abstracted instances and instance groups provided in an embodiment of the present application.

FIG. 3 is a flowchart of steps of an embodiment of another cloud application scheduling method of the present application.

FIG. 4 is a schematic diagram of an elastic scheduling process provided in an embodiment of the present application.

FIG. 5 is a structural block diagram of an embodiment of a cloud application scheduling apparatus in the present application.

### DESCRIPTION OF EMBODIMENTS

In order to make the above objects, features and advantages of the present application more obvious and understandable, the following will provide further detailed explanations of the present application in conjunction with accompanying drawings and specific implementations.

When providing a cloud application to the user for local use, the current cloud manufacturers implement the cloud applications using abstract concepts. However, due to the different characteristics of different operating systems, manufacturers have different scheduling granularities and methods for different operating systems, resulting in inconsistent concepts abstracted from different operating systems.

Traditional cloud application related projects such as cloud gaming can all be scheduled based on applications of a single operating system ecosystem. At this point, in order to enable applications in different ecosystems to be used on the same platform, a service developer needs to develop new scheduling logic and scheduling processes for different application ecosystems, that is, multiple sets of different code logic need to be designed to implement elastic scheduling of applications, resulting in high development costs; and in the case where the service developer develop different scheduling logic and scheduling processes for different application ecosystems, a cloud application manager also needs to understand different logical concepts in different application ecosystems, which is a too high cost for the cloud application manager to learn and understand.

One of core concepts of embodiments of the present application is to propose a unified abstraction manner by taking different application ecosystems as a whole, based on shielding cloud application managers and elastically scheduling perception of systems for underlying application ecosystems, it achieves a cloud application elastic scheduling system crossing the application ecosystems, while reducing the understanding cost of the cloud application managers and the service development cost of the service developers.

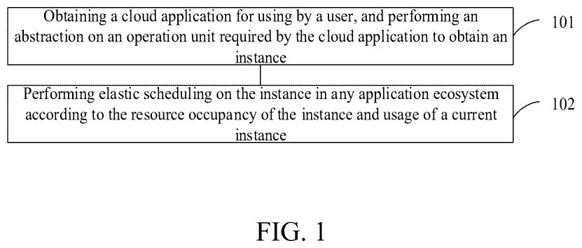

Referring to FIG. 1, a flowchart of steps of an embodiment of a cloud application scheduling method of the present application is shown, which is applied to a cloud application scheduling process, and can specifically include the following steps.

Step 101, obtaining a cloud application for using by a user, and performing an abstraction on an operation unit required by the cloud application to obtain an instance.

Cloud manufacturers can provide an application running in cloud resources to a user for local use. The application running in the cloud resources can be called a cloud application. Its working principle is mainly that it can change a use mode of traditional software “local installation and local computing” to “ready-to-use” services, so as to connect through the Internet or the local area network and control a remote server cluster to complete service logic or computing tasks, which can realize application virtualization based on resources on the cloud, and use cloud resources to run traditional software.

When providing the cloud application to the user for local use, the current cloud manufacturers implement cloud applications using abstract concepts. In order to avoid the different characteristics of different operating systems, manufacturers have different scheduling granularities and methods for different operating systems, resulting in inconsistent concepts for operation units abstracted from different operating systems. At this point, a unified abstraction manner is proposed by taking different application ecosystems as a whole, the operation unit required by the cloud application for using by the user is uniformly abstracted based on various different application ecosystems, so as to shield cloud application managers and elastically schedule the perception of systems for underlying application ecosystems, thereby achieving a cloud application elastic scheduling system crossing the application ecosystems.

In different application ecosystems, namely, in different operating systems, different software programs corresponding to different application ecosystems can be called as cross application ecosystems. The cross application ecosystem refers to an application where the user can experience multiple system ecosystems in a single system. The elastic scheduling can refer to dynamically increasing or releasing resources according to current service load requirements to achieve a goal of maximizing resource utilization.

At this point, the operation units of the different application ecosystems can be uniformly abstracted into the concept of instances and instance groups, and the logic and the process of elastic scheduling of cloud applications under different application ecosystems can be unified through the abstraction capabilities for different application ecosystems, so as to effectively reduce the development cost; and with the capability to abstract different application ecosystems, the cloud application manager can manage cloud applications with a unified logic without caring about the underlying application ecosystem, so as to effectively reduce the understanding cost of the system.

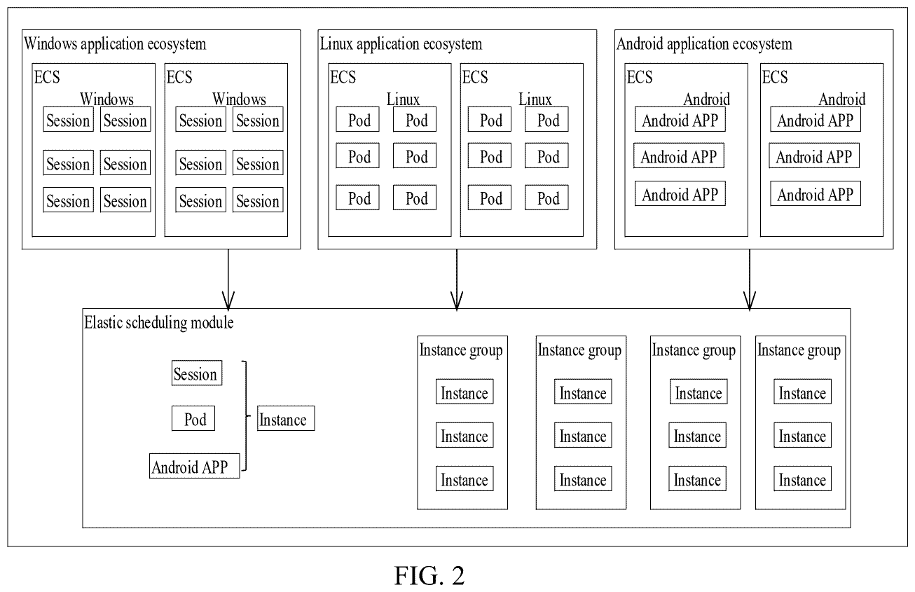

Specifically, referring to FIG. 2, a schematic diagram of abstracted instances and instance groups provided in an embodiment of the present application is shown. The various different application ecosystems can refer to different operation systems, such as the Linux ecosystem, the Windows ecosystem, and the Android ecosystem. Here, the cloud application for using by a user includes one or a set of running cloud applications for connection by the user, and then the abstracted instance can be a (group of) running cloud application(s) for connection by the user, that is, a connection between the user and the cloud application service can be regarded as an instance.

The operation units of the different application ecosystems are abstracted, the abstracted operation unit belongs to a unit of an operating system hierarchy, and it is not purely a underlying of the cloud application, nor a underlying resource, nor directly an operating system, which mainly has a concept that the data operated by different users on the same machine ESC (Elastic Compute Service, cloud server) is isolated from each other. The same machine operated by different users can be operated under the same operating system or under different operating systems, for example, when different users operate in the same windows machine, due to the different users logging in, although they are using the same operating system, the operation units operated by different users at this time are different instances in which the data are isolated, and the operation unit can include a operation space, operation information performed by the user in this space, and computing power allocated by the cloud application scheduling process for this operation space.

The operation units of different application ecosystems are abstracted, as an example, in the Linux ecosystem, due to the maturity of the pod technology, a line of connection available for service is corresponding to one Pod, and a plurality of applications can run in one Pod; and specifically, an operation unit required by one or a set of running cloud applications for connection by the user can be corresponding to a set of pods in the Linux ecosystem, and this set of pods are abstracted to obtain an instance; where one set (one or more) of pods can be equivalent to a Pod, and a Pod can be corresponding to a plurality of cloud applications and to one instance. As another example, in the Windows ecosystem, a line of connection available for service is corresponding to one logon session (Session), and a plurality of applications may also run in one Session; and specifically, an operation unit required by one or a set of running cloud applications for connection by the user can be corresponding to one system session window Session in the Windows ecosystem, and the system session window Session is abstracted to obtain an instance. As another example, in the Android ecosystem, a line of connection available for service is corresponding to one specific application; and specifically, an operation unit required by one or a set of running cloud applications for connection by the user can be corresponding to one Android APP in the Windows ecosystem, and the Android APP is abstracted to obtain an instance.

It should be noted that the system session window Session in the Windows ecosystem, the Pod in the Linux ecosystem, and the Android App in the Android system can be used as instances in the control scheduling process of the cloud application scheduling procedure, so as to be able to ignore the underlying system in the control process, and focus only on the number of reserved instances and the distributed machines; then, scheduling behavior can be generated based on the theoretical resource usage and total physical machine resources of each instance, which will be then distributed to the cloud environment.

In a practical application, as shown in FIG. 2, the instance group can refer to a set of a plurality of instances with the same configuration. An instance group (Instance Group) can include at least one instance abstracted as described above, such as including at least one Session, at least one Pod, or at least one Android APP. For the specific types or numbers of instances contained within a single instance group, FIG. 2 is only an example, which are not limited in embodiments of the present application. Preferably, additional configuration information, including a configuration parameter, an elastic strategy, etc., can be additionally specified in the instance group, that is, one instance can be associated with multiple instances, and the instance group can be associated with the configuration information and the elastic strategy.

Step 102, performing elastic scheduling on the instance in any application ecosystem according to the resource occupancy of the instance and usage of a current instance.

The logic and process of elastic scheduling of cloud applications under different application ecosystems can be unified through the abstraction capabilities for different application ecosystems, specifically, elastic scheduling can be performed on instances in any application ecosystems directly based on the resource occupancy of the instance and the usage of the current instance.

Where the differences of the underlying concepts are shielded in the elastic scheduling module through abstracting the operating units of different application ecosystems, specifically, a Linux Pod, an Android App, and a Windows Session can all be assigned with attributes that represent resource occupancy (e.g., a CPU, a memory, a hard disk, etc.), and running in a machine with finite resources (a CPU, a memory, a hard disk), the concept of the instance can be abstracted through this common character. In a concrete implementation, the Linux Pod, the Android App, and the Windows Session can be abstracted as instances with the attribute of resource occupancy, and different application ecosystems/operating systems can be defined as machines with the attribute of resource ownership.

In a practical application, the usage of the current instance can be determined based on the resource ownership and the resource occupancy. At this time, specifically, according to the configuration of the instance group where the instance is located, and combined with the usage of the current instance, that is, the scheduling behavior can be generated through the theoretical resource occupancy of each instance and the total amount of physical machine resource, and the generated scheduling behavior can be a corresponding scaling action, so as to unify the elastic scheduling of different application ecosystems.

In the embodiment of the present application, the operation unit required by the cloud application for using by the user are abstracted through the cloud application scheduling process, and the instance in any application ecosystem is elastically scheduled based on the resource occupancy of the abstracted instance and the usage of the current instance, where the abstracted instance is obtained by performing abstraction uniformly based on operation units of various different application ecosystems. That is, through utilizing the underlying abstraction capabilities for different application ecosystems, it achieves unified elastic scheduling capabilities for cloud applications in different application ecosystems, which not only reduces the development cost of the elastic scheduling function for the cloud application service manufacturer, but also provides the cloud application manager with a unified user experience and reduces the understanding cost.

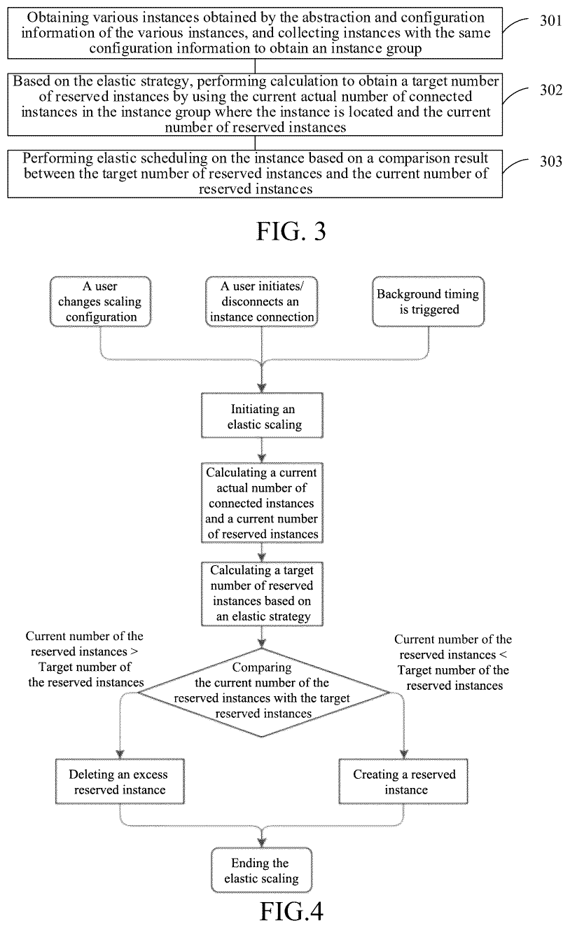

Referring to FIG. 3, a flowchart of steps of an embodiment of another cloud application scheduling method of the present application is shown, which is applied to a cloud application scheduling process, and can specifically include the following steps.

Step 301, obtaining various instances obtained by the abstraction and configuration information of the various instances, and collecting instances with the same configuration information to obtain an instance group.

In one embodiment of the present application, a unified abstraction manner is proposed by taking different application ecosystems as a whole, and the operation unit required by the cloud application for using by the user is uniformly abstracted based on various different application ecosystems, that is, different application ecosystems can be uniformly abstracted into the concepts of the instances and the instance groups. The logic and process of elastic scheduling of cloud applications under different application ecosystems can be unified through the abstraction capabilities for operation units of different application ecosystems, so as to effectively reduce the development cost; and with the capability to abstract different application ecosystems, the cloud application manager can manage cloud applications with a unified logic without caring about the underlying application ecosystem, so as to effectively reduce the understanding cost of the system.

Where, the cloud application for using by a user includes one or a set of running cloud applications for connection by the user, and then the abstracted instance can be a (group of) running cloud applications for connection by the user, that is, a line of connection available for service between the user and the cloud application service can be regarded as an instance.

In a practical application, as shown in FIG. 2, the instance group can refer to a collection of multiple instances with the same configuration, additional configuration information, including a configuration parameter, an elastic strategy, the number of instances, etc., can be additionally specified in the instance group, that is, one instance can be associated with multiple instances, and the instance group can be associated with the configuration information and the elastic strategy. The number of instances can essentially refer to the number of lines connected by the user. In this case, the resource occupancy of the instance is determined based on a current actual number of connected instances in the instance group where the instance is located, and the usage of the current instance can be determined based on a current number of reserved instances in the instance group where the instance is located.

Step 302, based on the elastic strategy, performing calculation to obtain a target number of reserved instances by using the current actual number of connected instances in the instance group where the instance is located and the current number of reserved instances.

In a practical application, at this time, specifically, according to the configuration of the instance group where the instance is located, and combined with the usage of the current instance, that is, the scheduling behavior can be generated through the theoretical resource occupancy of each instance and the total amount of physical machine resource, and the generated scheduling behavior can be a corresponding scaling action, so as to unify the elastic scheduling of different application ecosystems.

The configuration information for the configuration of an instance group can specifically include an instance type, a bound node pool, an application startup parameter, a mirror address, an elastic strategy, etc. The instance type can be used to define the amount of resources occupied by each instance, and the bound node pool can bound several nodes, the instance in this instance group can only be scheduled to the bound node pool. The mirror address can be used to pull an application mirror corresponding to the instance. The elastic strategy can define the minimum number of instances, the maximum number of instances, the reservation percentage, the maximum number of reserved instances, etc. in the instance group, so as to determine whether to add or delete instances based on the elastic strategy, and to determine whether to create or release nodes based on the machine node remaining resource in the node pool and the resource required by the instance.

In an embodiment of the present application, the resource occupancy of the instance may be determined based on a current actual number of connected instances in the instance group where the instance is located, and the usage of the current instance may be determined based on a current number of reserved instances in the instance group where the instance is located; and then, according to the elastic strategy, the instance can be elastically scheduled by using the current actual number of connected instances in the instance group where the instance is located and the current number of reserved instances.

As an example, under the situation that the user changes the scaling configuration, initiates/disconnects an instance connection, background timing is triggered, etc., the elastic scaling can be initiated, that is, the instance is scaled.

Specifically, referring to FIG. 4, a schematic diagram of an elastic scheduling process provided in an embodiment of the present application is shown. A target number of reserved instances may be calculated by using the current actual number of connected instances in the instance group where the instance is located and the current number of reserved instances. For example, when calculating the current actual number of connected instances and the current number of reserved instances, it is assumed that the current actual number of connected instances is 50, the current number of reserved instances is 3, and the current total number of instances is 53, then when calculating the target number of reserved instances based on the elastic strategy, the scaling rule based on the current actual number of connected instances configured by the customer can be based on and the target number of reserved instances=current actual number of connected instances (50)*reservation ratio (10%)=5.

Step 303, performing elastic scheduling on the instance based on a comparison result between the target number of reserved instances and the current number of reserved instances.

The unified logic and process of elastic scheduling of cloud applications in different application ecosystems can be manifested as determining whether to add or delete instances based on the elastic strategy. Specifically, when the comparison result is that the current number of reserved instances is greater than the target number of reserved instances, it deletes an excess reserved instance; and when the comparison result is that the current number of reserved instances is less than the target number of reserved instances, it creates a reserved instance to reserve the instance.

As an example, it is assumed that the current number of reserved instances is 3, and the target number of reserved instances calculated based on the current actual number of connected instances and the current number of reserved instances is 5, then 2 reserved instances can be created, thereby increasing the total number of instances from 53 to 55.

Specifically, the instance group where the instance is located is bound to a node pool, the node pool is bound to several machine nodes, the bound node pool has a machine node remaining resource, the current number of reserved instances can be calculated based on the strategy configured by the user in the instance group, and the usage of the current instance can be determined based on a required resource of the instance in the instance group. At this point, it can be determined whether to create a new node or release a node based on the machine node remaining resource in the node pool and the resource required by the instance.

Then, when deleting the an excess reserved instance, in a case where the machine node remaining resource is greater than the required resource, it is possible to delete the an excess reserved instance through performing a release operation on a node in the node pool bound to the instance group where the instance is located. When creating the reserved instance to reserve the instance, since the instance of this instance group can only be scheduled to the bound node pool, when the machine node remaining resource is less than the required resource, it is possible to perform a new operation on a node in the node pool bound to the instance group where the instance is located, to schedule the excess reserved instance of the instance group where the instance is located to a new node to create the reserved instance.

It should be noted that, in addition to proposing a unified abstraction manner by taking different application ecosystems as a whole in the embodiments of the present application, and based on shielding cloud application managers and elastically scheduling the perception of systems for underlying application ecosystems, achieving a cloud application elastic scheduling across the application ecosystems, it is also possible to develop an elastic scheduling strategy separately for each application ecosystem, and have different abstract concepts to achieve elastic scheduling of cloud applications across application ecosystems.

In the embodiment of the present application, the operation unit required by the cloud application for using by the user are abstracted through the cloud application scheduling process, and the instance in any application ecosystem is elastically scheduled based on the resource occupancy of the abstracted instance and the usage of the current instance, where the abstracted instance is obtained by performing abstraction uniformly based on operation units of various different application ecosystems. That is, through utilizing underlying abstraction capabilities for different application ecosystems, it achieves unified elastic scheduling capabilities for cloud applications in different application ecosystems, which not only reduces the development cost of the elastic scheduling function for the cloud application service manufacturer, but also provides the cloud application manager with a unified user experience and reduces the understanding cost.

It should be noted that, for the sake of simplicity, the method embodiments are described as a series of action combinations. However, those skilled in the art should be aware that the embodiments of the present application are not limited by the order of the described actions, the reason is that certain steps may be performed in other orders or simultaneously according to the embodiments of the present application. Secondly, those skilled in the art should also be aware that the embodiments described in the specification are all preferred embodiments, and the actions involved are not necessarily necessary for the embodiments of the present application.

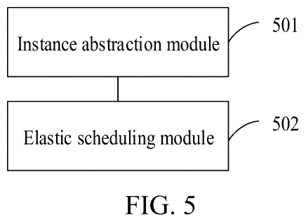

Referring to FIG. 5, a structural block diagram of an embodiment of a cloud application scheduling apparatus in the present application is shown, which can specifically include the following modules:
an instance abstraction module 501, configured to obtain a cloud application for using by a user, and perform an abstraction on an operation unit required by the cloud application to obtain an instance; where the instance is obtained by performing abstraction uniformly based on operation units of various different application ecosystems, and the instance includes resource occupancy;
an elastic scheduling module 502, configured to perform elastic scheduling on the instance in any application ecosystem according to the resource occupancy of the instance and usage of a current instance.

In one embodiment of the present application, the cloud application for using by the user includes one or a set of running cloud applications for connection by the user, the various different application ecosystems includes a Linux ecosystem, a Windows ecosystem, and an Android ecosystem, the instance abstraction module 501 may include the following sub-modules:
an instance abstraction sub-module, configured to, in the Linux ecosystem, map an operation unit required by one or a set of running cloud applications for connection by the user to a set of pods in the Linux ecosystem, and abstract the pod to obtain the instance; and/or, in the Windows ecosystem, map an operation unit required by one or a set of running cloud applications for connection by the user to a system session window in the Windows ecosystem, and abstract the system session window to obtain the instance; and/or, in the Android ecosystem, map an operation unit required by one or a set of running cloud applications for connection by the user to an application in the Android ecosystem, and abstract the application to obtain the instance.

In one embodiment of the present application, the apparatus may further include the following modules:
an instance group collection module, configured to obtain various instances obtained by the abstraction and configuration information of the various instances, and collect instances with the same configuration information to obtain an instance group.

In one embodiment of the present application, the configuration information of the instance group where the instance is located includes an elastic strategy, the resource occupancy of the instance is determined based on a current actual number of connected instances in the instance group where the instance is located, and the usage of the current instance is determined based on a current number of reserved instances in the instance group where the instance is located.

The elastic scheduling module 502 may include the following sub-modules:
a target reserved instance number determination sub-module, configured to, based on the elastic strategy, performing calculation to obtain a target number of reserved instances by using the current actual number of connected instances in the instance group where the instance is located and the current number of reserved instances;
an elastic scheduling sub-module, configured to perform the elastic scheduling on the instance based on a comparison result between the target number of reserved instances and the current number of reserved instances.

In one embodiment of the present application, the elastic scheduling sub-module may further include the following units:
a reserved instance deletion unit, configured to delete an excess reserved instance when the comparison result is that the current number of reserved instances is greater than the target number of reserved instances;
a reserved instance creation unit, configured to create a reserved instance to reserve the instance when the comparison result is that the current number of reserved instances is less than the target number of reserved instances.

In one embodiment of the present application, the instance group where the instance is located is bound to a node pool, the node pool is bound to several machine nodes, a machine node remaining resource exists in the bound node pool, and the usage of the current instance is determined based on a required resource of the instance in the instance group;
the reserved instance deletion unit may include the following sub-units:
a node releasing sub-unit, configured to, when the machine node remaining resource is greater than the required resource, delete the excess reserved instance through performing a release operation on a node in the node pool bound to the instance group where the instance is located.

In one embodiment of the present application, the instance group where the instance is located is bound to a node pool, the node pool is bound to several machine nodes, a machine node remaining resource exists the bound node pool, and the usage of the current instance is determined based on a required resource of the instance in the instance group;
the reserved instance creation unit may include the following sub-units:
a node creation sub-unit, configured to, when the machine node remaining resource is less than the required resource, create the reserved instance through performing a new creation operation on a node in the node pool bound to the instance group where the instance is located, and schedule the excess reserved instance of the instance group where the instance is located to a new created node.

For the apparatus embodiments, since it is substantially similar to the method embodiments, the description is relatively simple, and it is sufficient to refer to the partial description of the method embodiments where relevant.

An embodiment of the present application further provides an electronic device, including:
a processor, a memory, and a computer program stored in the memory and capable of running in the processor; when executed by the processor, the computer program achieves the various processes of the embodiments of the cloud application scheduling method described above, and can achieve the same technical effects. In order to avoid repetition, it will not be repeated here.

An embodiment of the present application further provides a computer readable storage medium, where the computer readable storage medium stores a computer program which; when executed by the processor, achieves the various processes of the embodiments of the cloud application scheduling method described above, and can achieve the same technical effects. In order to avoid repetition, it will not be repeated here.

The various embodiments in this specification are described in a progressive manner, with each embodiment emphasizing its differences from other embodiments, and the same and similar parts between the various embodiments can be referred to each other.

Those skilled in the art should understand that the embodiments of the present application can be provided as a method, an apparatus, or a computer program product. Therefore, the embodiments of the present application may take the form of fully hardware embodiments, fully software embodiments, or embodiments combining software and hardware aspects. Moreover, the embodiments of the present application may take a form of a computer program product implemented on one or more computer usable storage media containing a computer usable program code (including but not limited to a disk storage, a CD-ROM, an optical memory, etc.).

The embodiments of the present application are described with reference to the flowcharts and/or block diagrams of the method, the terminal device (system), and the computer program product according to the embodiments of the present application. It should be understood that each process and/or block in the flowcharts and/or block diagrams, as well as the combination of processes and/or blocks in the flowcharts and/or block diagrams, can be implemented by computer program instructions. These computer program instructions can be provided to a general purpose computer, a special purpose computer, an embedded processing machine, or a processor of other programmable data processing terminal device to generate a machine, such that the instructions executed by the computer or the processor of other programmable data processing terminal device generate an apparatus for implementing the function specified in one or more processes of the flowcharts and/or one or more blocks of the block diagrams.

These computer program instructions can also be stored in a computer-readable memory that can guide a computer or other programmable data processing terminal device to operate in a specific manner, such that the instructions stored in the computer-readable memory generate a manufacture including an instruction device, and the instruction device implements the function specified in one or more processes of a flowchart and/or one or more blocks of a block diagram.

These computer program instructions can also be loaded onto a computer or other programmable data processing terminal device, enabling a series of operational steps to be executed in the computer or other programmable terminal device to generate computer implemented processing, so that the instructions executed in the computer or other programmable terminal device provide steps for implementing the function specified in one or more processes of a flowchart and/or one or more blocks of a block diagram.

Although preferred embodiments of the present application have been described, those skilled in the art may make additional changes and modifications to these embodiments once they have known the basic inventive concept. Therefore, the attached claims are intended to be interpreted as including preferred embodiments and all changes and modifications falling within the scope of the embodiments of the present application.

Finally, it should be noted that in the present application, relational terms such as first and second are only used to distinguish one entity or operation from another entity or operation, and do not necessarily require or imply that any actual relationship or order exist between these entities or operations. Moreover, the terms “comprise”, “include”, or any other variation thereof are intended to encompass non-exclusive inclusion, such that a process, a method, an item, or a terminal device including a series of elements not only includes those elements, but also includes other elements that are not explicitly listed, or also includes elements inherent to such the process, the method, the item, or the terminal device. Without further limitation, an element defined by the phrase “including a . . . ” does not exclude the existence of other identical elements in the process, the method, the item or the terminal device including the element.

The above provides a detailed introduction to the cloud application scheduling method, the cloud application scheduling apparatus, the corresponding electronic device, and the corresponding computer storage medium provided in the present application. Specific examples are used in the present application to explain principles and implementations of the present application. The above embodiments are only used to help understand the methods and the core ideas thereof of the present application. At the same time, for those of ordinary skill in the art, there may be changes in the specific implementation and application scope based on the ideas of the present application. In summary, the content of this specification should not be understood as limiting the present application.

1. A cloud application scheduling method, applied to a cloud application scheduling process, wherein the method comprises:
obtaining a cloud application for using by a user, and performing an abstraction on an operation unit required by the cloud application to obtain an instance; wherein the instance is obtained by performing abstraction uniformly based on operation units of various different application ecosystems, and the instance comprises resource occupancy;
performing elastic scheduling on the instance in any application ecosystem according to the resource occupancy of the instance and usage of a current instance.

2. The method according to claim 1, wherein the cloud application for using by the user comprises one or a set of running cloud applications for connection by the user, the various different application ecosystems comprises a Linux ecosystem, a Windows ecosystem, and an Android ecosystem, the performing the abstraction on the operation unit required by the cloud application to obtain the instance comprises:
in the Linux ecosystem, mapping an operation unit required by one or a set of running cloud applications for connection by the user to a set of pods in the Linux ecosystem, and abstracting the pod to obtain the instance;
and/or, in the Windows ecosystem, mapping an operation unit required by one or a set of running cloud applications for connection by the user to a system session window in the Windows ecosystem, and abstracting the system session window to obtain the instance;
and/or, in the Android ecosystem, mapping an operation unit required by one or a set of running cloud applications for connection by the user to an application in the Android ecosystem, and abstracting the application to obtain the instance.

3. The method according to claim 1, further comprising:
obtaining various instances obtained by the abstraction and configuration information of the various instances, and collecting instances with the same configuration information to obtain an instance group.

4. The method according to claim 1, wherein the configuration information of the instance group where the instance is located comprises an elastic strategy, the resource occupancy of the instance is determined based on a current actual number of connected instances in the instance group where the instance is located, and the usage of the current instance is determined based on a current number of reserved instances in the instance group where the instance is located;
the performing the elastic scheduling on the instance in any application ecosystem according to the resource occupancy of the instance and the usage of the current instance comprises:
based on the elastic strategy, performing calculation to obtain a target number of reserved instances by using the current actual number of connected instances in the instance group where the instance is located and the current number of reserved instances;
performing the elastic scheduling on the instance in any application ecosystem based on a comparison result between the target number of reserved instances and the current number of reserved instances.

5. The method according to claim 4, wherein the performing the elastic scheduling on the instance in any application ecosystem based on the comparison result between the target number of reserved instances and the current number of reserved instances comprises:
based on that the comparison result is that the current number of reserved instances is greater than the target number of reserved instances, deleting an excess reserved instance;
based on that the comparison result is that the current number of reserved instances is less than the target number of reserved instances, creating a reserved instance to reserve the instance.

6. The method according to claim 5, wherein the instance group where the instance is located is bound to a node pool, the node pool is bound to several machine nodes, a machine node remaining resource exists in the bound node pool, and the usage of the current instance is determined based on a required resource of the instance in the instance group;
the deleting the excess reserved instance comprises:
when the machine node remaining resource is greater than the required resource, deleting the excess reserved instance through performing a release operation on a node in the node pool bound to the instance group where the instance is located.

7. The method according to claim 5, wherein the instance group where the instance is located is bound to a node pool, the node pool is bound to several machine nodes, a machine node remaining resource exists the bound node pool, and the usage of the current instance is determined based on a required resource of the instance in the instance group;
the creating the reserved instance to reserve the instance comprises:
when the machine node remaining resource is less than the required resource, creating the reserved instance through performing a new creation operation on a node in the node pool bound to the instance group where the instance is located, and scheduling the excess reserved instance of the instance group where the instance is located to a new created node.

8. A cloud application scheduling apparatus, applied to a cloud application scheduling process, wherein the apparatus comprises:
a processor, a memory, and a computer program stored in the memory and capable of running in the processor; wherein the computer program, when executed by the processor, causes the processor to:
obtain a cloud application for using by a user, and perform an abstraction on an operation unit required by the cloud application to obtain an instance;
wherein the instance is obtained by performing abstraction uniformly based on operation units of various different application ecosystems, and the instance comprises resource occupancy;
perform elastic scheduling on the instance in any application ecosystem according to the resource occupancy of the instance and usage of a current instance.

9. (canceled)

10. A non-transitory computer readable storage medium, storing computer program which, when executed by the processor, causes the processor to implement the following:
obtaining a cloud application for using by a user, and performing an abstraction on an operation unit required by the cloud application to obtain an instance; wherein the instance is obtained by performing abstraction uniformly based on operation units of various different application ecosystems, and the instance comprises resource occupancy;
performing elastic scheduling on the instance in any application ecosystem according to the resource occupancy of the instance and usage of a current instance.

11. The apparatus according to claim 8, wherein the cloud application for using by the user comprises one or a set of running cloud applications for connection by the user, the various different application ecosystems comprises a Linux ecosystem, a Windows ecosystem, and an Android ecosystem;
the processor is further caused to:
in the Linux ecosystem, map an operation unit required by one or a set of running cloud applications for connection by the user to a set of pods in the Linux ecosystem, and abstract the pod to obtain the instance;
and/or, in the Windows ecosystem, map an operation unit required by one or a set of running cloud applications for connection by the user to a system session window in the Windows ecosystem, and abstract the system session window to obtain the instance;
and/or, in the Android ecosystem, map an operation unit required by one or a set of running cloud applications for connection by the user to an application in the Android ecosystem, and abstract the application to obtain the instance.

12. The apparatus according to claim 8, wherein the processor is further caused to:
obtain various instances obtained by the abstraction and configuration information of the various instances, and collect instances with the same configuration information to obtain an instance group.

13. The apparatus according to claim 8, wherein the configuration information of the instance group where the instance is located comprises an elastic strategy, the resource occupancy of the instance is determined based on a current actual number of connected instances in the instance group where the instance is located, and the usage of the current instance is determined based on a current number of reserved instances in the instance group where the instance is located;
the processor is further caused to:
based on the elastic strategy, perform calculation to obtain a target number of reserved instances by using the current actual number of connected instances in the instance group where the instance is located and the current number of reserved instances;
perform the elastic scheduling on the instance based on a comparison result between the target number of reserved instances and the current number of reserved instances.

14. The apparatus according to claim 13, wherein the processor is further caused to:
based on that the comparison result is that the current number of reserved instances is greater than the target number of reserved instances, delete an excess reserved instance;
based on that the comparison result is that the current number of reserved instances is less than the target number of reserved instances, create a reserved instance to reserve the instance.

15. The apparatus according to claim 14, wherein the instance group where the instance is located is bound to a node pool, the node pool is bound to several machine nodes, a machine node remaining resource exists in the bound node pool, and the usage of the current instance is determined based on a required resource of the instance in the instance group;
the processor is further caused to:
when the machine node remaining resource is greater than the required resource, delete the excess reserved instance through performing a release operation on a node in the node pool bound to the instance group where the instance is located.

16. The apparatus according to claim 14, wherein the instance group where the instance is located is bound to a node pool, the node pool is bound to several machine nodes, a machine node remaining resource exists the bound node pool, and the usage of the current instance is determined based on a required resource of the instance in the instance group;
the processor is further caused to:
when the machine node remaining resource is less than the required resource, create the reserved instance through performing a new creation operation on a node in the node pool bound to the instance group where the instance is located, and schedule the excess reserved instance of the instance group where the instance is located to a new created node.

17. The storage medium according claim 10, wherein the cloud application for using by the user comprises one or a set of running cloud applications for connection by the user, the various different application ecosystems comprises a Linux ecosystem, a Windows ecosystem, and an Android ecosystem;
the processor is further caused to implement the following:
in the Linux ecosystem, mapping an operation unit required by one or a set of running cloud applications for connection by the user to a set of pods in the Linux ecosystem, and abstracting the pod to obtain the instance;
and/or, in the Windows ecosystem, mapping an operation unit required by one or a set of running cloud applications for connection by the user to a system session window in the Windows ecosystem, and abstracting the system session window to obtain the instance;
and/or, in the Android ecosystem, mapping an operation unit required by one or a set of running cloud applications for connection by the user to an application in the Android ecosystem, and abstracting the application to obtain the instance.

18. The storage medium according claim 10, wherein the processor is further caused to implement the following:
obtaining various instances obtained by the abstraction and configuration information of the various instances, and collecting instances with the same configuration information to obtain an instance group.

19. The storage medium according claim 10, wherein the configuration information of the instance group where the instance is located comprises an elastic strategy, the resource occupancy of the instance is determined based on a current actual number of connected instances in the instance group where the instance is located, and the usage of the current instance is determined based on a current number of reserved instances in the instance group where the instance is located;
the processor is further caused to implement the following:
based on the elastic strategy, performing calculation to obtain a target number of reserved instances by using the current actual number of connected instances in the instance group where the instance is located and the current number of reserved instances;
performing the elastic scheduling on the instance based on a comparison result between the target number of reserved instances and the current number of reserved instances.

20. The storage medium according claim 19, wherein the processor is further caused to implement the following:
based on that the comparison result is that the current number of reserved instances is greater than the target number of reserved instances, deleting an excess reserved instance;
based on that the comparison result is that the current number of reserved instances is less than the target number of reserved instances, creating a reserved instance to reserve the instance.

21. The storage medium according claim 20, wherein the instance group where the instance is located is bound to a node pool, the node pool is bound to several machine nodes, a machine node remaining resource exists in the bound node pool, and the usage of the current instance is determined based on a required resource of the instance in the instance group;
the processor is further caused to implement the following:
when the machine node remaining resource is greater than the required resource, deleting the excess reserved instance through performing a release operation on a node in the node pool bound to the instance group where the instance is located.
